(19) United States
(12) Patent Application Publication
(10) Pub. No.: US 2011/0076864 A1
(43) Pub. Date: Mar. 31, 2011

(54) CONNECTOR AND DISPLAY APPARATUS HAVING THE SAME

(76) Inventors: Joo-Yeon WON, Seoul (KR); YongSoon LEE, Cheonan-si (KR); OckJin KIM, Asan-si (KR); Sang-Gon LEE, Seo-gu (KR); Seunghwan MOON, Asan-si (KR)

(21) Appl. No.: 12/787,423

(22) Filed: May 26, 2010

(30) Foreign Application Priority Data
Sep. 30, 2009 (KR) 10-2009-0093288

(51) Int. Cl. H01R 12/24

(52) U.S. Cl. 439/77; 439/492

(57) ABSTRACT

A connector and a display apparatus having the same. The connector receives a flexible substrate to transfer signals from the flexible substrate to an external device. The connector includes a housing, a first support part, and a second support part. The housing has a receiving space to receive the flexible substrate. The first support part has a first concave-convex part protruding toward the receiving space. The second support part has a second concave-convex part protruding toward the first concave-convex part. Concave and convex parts of the first concave-convex part convex and concave parts of the second concave-convex part engage the flexible substrate to fix the flexible substrate, and at least one of the first and second support parts electrically contacts the flexible substrate.

### CROSS-REFERENCE TO RELATED APPLICATION

This application relies for priority upon Korean Patent Application No. 2009-93288 filed on Sep. 30, 2009, the contents of which are herein incorporated by reference in their entirety.

### BACKGROUND OF THE INVENTION

1. Technical Field of the Invention

The present invention relates to a connector and a display apparatus having the same.

2. Discussion of the Related Art

Instead of a conventional cathode ray tube (CRT), various display apparatuses such as a liquid crystal display (LCD), a plasma display panel (PDP), and an electrophoretic display (EPD) have been extensively used for a computer monitor, a television, and so on.

The display apparatuses include a display panel to display images. The display apparatuses can use a converter to convert image signals into driving signals. The image signals are generated from a controller, which controls the images, and the converter is connected with the controller through a connector.

As the size and the resolution of the display panel are increased, large signals are transferred between the display panel and the controller at a high data rate.

### SUMMARY OF THE INVENTION

Exemplary embodiments of the present invention provide a connector capable of securely fixing a flexible substrate, and a display apparatus having the connector capable of securely fixing a flexible substrate.

In one aspect, a connector according to an embodiment of the present invention receives a flexible substrate to transfer signals from the flexible substrate to an external device. The connector includes a housing, a first support part, and a second support part. The housing has a receiving space to receive the flexible substrate. The first support part has a first concave-convex part protruding toward the receiving space. The second support part has a second concave-convex part protruding toward the first concave-convex part.

Concave and convex parts of the first concave-convex part and convex and concave parts of the second concave-convex part engage the flexible substrate to fix the flexible substrate, and at least one of the first and second support parts electrically contacts the flexible substrate.

At least one of the first and second support parts is connected with a terminal connection part having one end exposed to an exterior. The terminal connection part includes a conductor, and at least one of the first and second support parts connected with the terminal connection part includes a conductor.

The flexible substrate is inserted into the receiving space and received in the receiving space, and the convex parts of the first and second support parts overlap with at least one of two surfaces of the flexible substrate extending in parallel to an insertion direction of the flexible substrate.

The first concave-convex part may be offset from a position of the second concave-convex part when viewed in the insertion direction of the flexible substrate.

The first and second concave-convex parts may each include a plurality of concave and convex parts, and a number of the concave and convex parts of the second concave-convex part may correspond to a number of the concave and convex parts of the first concave-convex part.

A connection part connecting the first support part with the second support part may be provided between the first and second support parts. The first and second support parts and the connection part may be integrated with each other.

The second support part may be integrated with the housing.

The first concave-convex part is provided at one end of the first support part. The connector further includes a fixing member which is contacted with another end of the first support part to apply an force on the other end of the first support part. The force is in a direction opposite to a protrusion direction of the first concave-convex part (i.e., away from the receiving space) to move the first concave-convex part in a direction toward the receiving space, thereby reducing a space between the first and second concave-convex parts.

In another aspect, the connector according to an embodiment of the present invention is adaptable for a display apparatus. The display apparatus including the connector includes a printed circuit board, a flexible substrate, and a display panel. The printed circuit board may output a driving signal. The connector is mounted on the printed circuit board. The flexible substrate is inserted into the connector and coupled with the connector. The display panel is connected with the flexible substrate and receives the driving signal through the connector and the flexible substrate to display an image on a front surface. The flexible substrate may have a thickness of about 15 μm to about 18 μm.

At least one of the first and second support parts is connected with a terminal connection part having an end exposed to an exterior. The terminal connection part may be connected with the printed circuit board.

The printed circuit board may be provided at a rear surface of the display panel, or provided at a side portion of the display panel in parallel to the front surface of the display panel.

If the printed circuit board is provided at a side portion of the display panel, the connector may be provided on a top surface of the printed circuit board or a bottom surface of the printed circuit board.

As described above, if the flexible substrate is simply fitted into the connector, the flexible substrate can be electrically connected with the connector. Accordingly, the connector can be securely connected with the flexible substrate without an additional bonding process.

As a result, the assembling process of the display apparatus including the connector can be simplified. Therefore, the manufacturing time and cost of the display apparatus can be reduced.

### BRIEF DESCRIPTION OF THE DRAWINGS

Exemplary embodiments of the present invention will become readily apparent by reference to the following detailed description when considered in conjunction with the accompanying drawings wherein:

FIG. 1 is a perspective view showing a portion of a connector according to an embodiment of the present invention;

FIG. 2A is a sectional view showing a connector according to an embodiment of the present invention which is not connected with a flexible substrate;

FIG. 2B is a sectional view showing a connector according to an embodiment of the present invention which is connected with a flexible substrate;

FIG. 3 is a sectional view showing a portion of the connector according to an embodiment of the present invention when the flexible substrate is fitted into a receiving space of the connector;

FIG. 4 is a perspective view showing a portion of a connector according to an embodiment of the present invention;

FIG. 5 is a sectional view showing a portion of a connector according to an embodiment of the present invention when a flexible substrate is fitted into a receiving space of the connector;

FIG. 6 is a schematic view showing a display apparatus including the connector according to an embodiment of the present invention; and

FIGS. 7A to 7E are sectional views showing mounting positions of the connector according to the positions of a printed circuit board in the display apparatus according to embodiments of the present invention.

### DESCRIPTION OF THE EMBODIMENTS

Hereinafter, a connector and a display apparatus having the same according to embodiments of the present invention will be described with reference to the accompanying drawings.

The present invention may be embodied in many different forms and is not limited to the embodiments set forth herein. The size of the layers and regions in the drawings along with the embodiments may be simplified or exaggerated for purposes of explanation or emphasis.

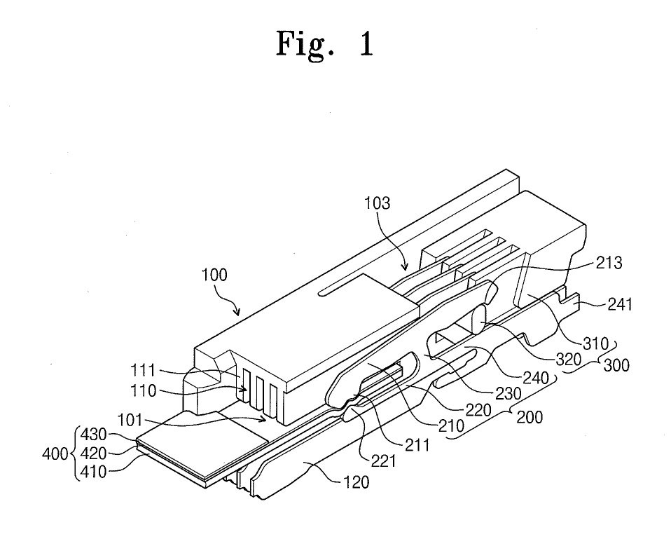

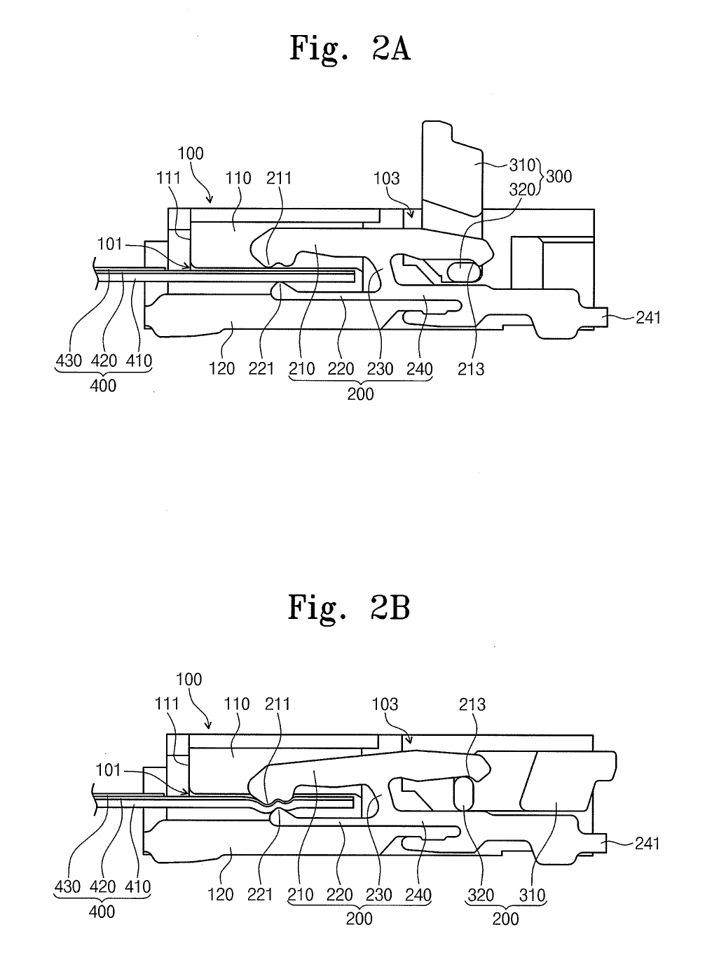

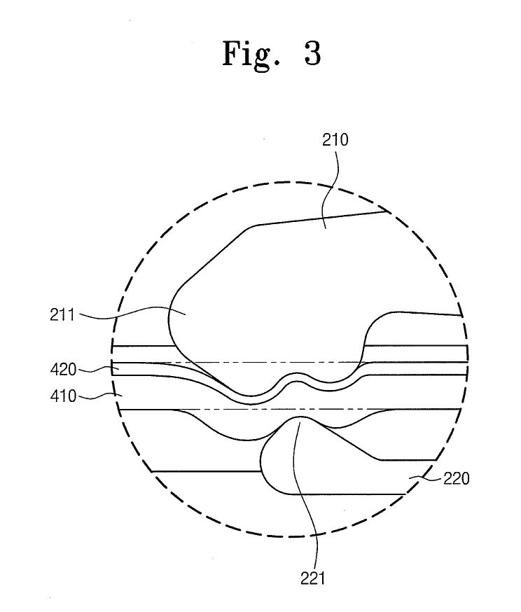

FIG. 1 is a perspective view showing a portion of a connector according to an embodiment of the present invention. FIG. 2A is a sectional view showing a connector according to an embodiment of the present invention which is not connected with a flexible substrate, and FIG. 2B is a sectional view showing a connector according to an embodiment of the present invention which is connected with the flexible substrate.

Referring to FIGS. 1, 2A, and 2B, the connector according to an embodiment of the present invention is used to transfer signals between a flexible substrate 400 and an external device. The connector includes a housing 100 having a receiving space to receive the flexible substrate 400, a terminal part 200 disposed inside the housing 100, and a fixing member 300 to fix the flexible substrate 400 by applying a force on a portion of the terminal part 200 to move the portion of the terminal part 200.

The flexible substrate 400 supplies various signals including an image signal to an external device and/or receives various signals from an external device. The flexible substrate 400 has a planar shape. The flexible substrate 400 provides a driving signal to the display panel in the display apparatus such that the display panel is driven. However, the present invention is not limited thereto. For example, according to an embodiment, the flexible substrate 400 may include a flexible flat cable used in the display apparatus or other apparatuses.

The flexible substrate 400 includes an insulation film 410 and a metallic layer 420 formed on the insulation film 410.

The metallic layer 420 may have various patterns according to required circuits. The metallic layer 420 includes conductive metal such as copper (Cu), nickel (Ni), gold (Au), or chrome (Cr). The metallic layer 420 may be formed as a single layer or a multi-layer including the metal. According to an embodiment, the metallic layer 420 may include an alloy of the metal. In addition, the metallic layer 420 may be formed at one side or both sides of the insulation film 410. An integrated circuit may be formed on both sides of the insulation film 410.

The insulation film 410 includes an insulation material such as polymer. The polymer serving as the insulation film 410 includes, for example, polyimide, polyester, and so on.

In addition, a protective layer 430 may be formed on a portion of the metallic layer 420 to protect the metallic layer 420. However, the protective layer 430 is not formed where the flexible substrate 400 contacts the connector in order to electrically connect the flexible substrate 400 with the connector. For example, if the contact part between the flexible substrate 400 and the connector is an end part, the protective layer 430 is not formed at the end part so that the metallic layer 420 is exposed to an exterior.

The housing 100 forms an external appearance of the connector and includes an insulation material. The housing 100 has a rectangular parallelepiped shape extending substantially lengthwise in a direction. The housing 100 is not limited to the insulation material, but may include polymer such as teflon, polyethylene, or polypropylene. The housing 100 may have a single structure, or, according to an embodiment, may be the assembly of several pieces.

A first opening 101 is formed at a front surface of the housing 100. The housing 100 has a receiving space to receive the flexible substrate 400. The receiving space is formed from the front surface of the housing 100 toward a rear surface thereof through the first opening 101.

A direction from a bottom surface toward a top surface of the flexible substrate 400 is referred to as an upper direction, and a direction opposite to the upper direction is referred to as a lower direction. In addition, a surface of the housing 100 on which the first opening 101 allowing the insertion of the flexible substrate 400 is formed is referred to as the front surface, and a surface opposite to the front surface is referred to as the rear surface. A direction in which the flexible substrate 400 is inserted is referred to as a direction toward the rear surface (or a rear direction) and a direction opposite to the direction toward the rear surface is referred to as the direction toward the front surface direction (or a front direction). In addition, directions perpendicular to the upper and lower directions and the front and rear directions are referred to as left and right directions.

The housing 100 includes an upper housing 110 and a lower housing 120 facing the upper housing 110 while interposing the receiving space therebetween. Sidewalls are formed at left and right sides of the upper and lower housings 110 and 120 to connect the upper housing 110 with the lower housing 120.

The shape of the receiving space of the housing 100 is substantially identical to the shape of an end of the flexible substrate 400. If the flexible substrate 400 has the shape of a rectangular plane extending longer in the left and right directions than the front and rear directions, the receiving space has a narrow width at the upper and lower portions thereof and has a wide width at left and right portions thereof such that the receiving space has substantially the same shape of the rectangular plane corresponding to the shape of the flexible substrate 400.

According to an embodiment of the present invention, the flexible substrate 400 has the shape of a plane extending in the left and right directions, wherein the length of the flexible substrate 400 is longer in the left and right directions than in the front and rear directions. However, since FIGS. 2A and 2B are sectional views taken perpendicularly to the left and right directions, the length of the flexible substrate 400 appears to be shorter in the left and right directions.

A portion of the upper housing 110 provided at the rear surface is removed, thereby forming a second opening 103 at the portion of the upper housing 110 provided at the rear surface to allow the fixing member 300 to be movable. The second opening 103 provides an area in which the fixing member 300 is movable to fix the flexible substrate 400 when the flexible substrate 400 is inserted into the receiving space of the housing 100.

The upper housing 110 includes a first support wall 111 having a comb-shaped groove part on a bottom surface of the upper housing. The first support wall 111 is integrally formed with the upper housing 110 while facing the lower housing 120. Similar to the upper housing 110, the lower housing 120 includes a second support wall (not shown) having a comb-shaped groove part on an upper surface of the lower housing 120. The second support wall is integrally formed with the lower housing 120 and faces the upper housing 110.

The terminal part 200 is electrically connected with the flexible substrate 400 in order to receive electrical signals from the flexible substrate 400. The entire portion or at least a portion of the terminal part 200 includes a conductive material in order to make electrical contact with the flexible substrate 400.

The terminal part 200 includes a first support part 210, a second support part 220, a connection part 230 connecting the first support part 210 with the second support part 220, and a terminal connection part 240 having a first end connected with the second support part 220 and a second end exposed to an exterior. The second end is disposed opposite to the first end. A plurality of first support parts 210 may be positioned between a plurality of protrusions in grooves of the comb-like structure in the housing.

The first support part 210 has a first concave-convex part 211 protruding toward the receiving space. The second support part 220 has a second concave-convex part 221 protruding toward the first concave-convex part 211. According to an embodiment of the present invention, as shown in FIG. 1, a plurality of first and second support parts 210 and 220 are provided in order to transfer various signals.

The first support part 210 is interposed between the comb-shaped groove parts of the first support wall 111. The first support part 210 extends in the front and rear directions. The first support part 210 includes, at a first end thereof, the first concave-convex part 211 protruding in the direction toward the receiving space, that is, the lower direction.

The second support part 220 is interposed between the comb-shaped groove parts of the second support wall. The second support part 220 extends in the front and rear directions. The second support part includes, at a first end thereof, the second concave-convex part 221 protruding in the direction toward the receiving space, that is, the upper direction.

The first and second concave-convex parts 211 and 221 have concave parts and convex parts. If a predetermined area protrudes from neighboring areas, the predetermined area corresponds to a convex part. If a predetermined area is recessed from neighboring areas, the predetermined area corresponds to a concave part.

The concave and convex parts of the first concave-convex part 211 are engaged with the convex and concave parts of the second concave-convex part 221 such that the flexible substrate 400 is firmly fixed. In other words, the concave and convex parts of the first concave-convex part 211 correspond to the convex and concave parts of the second concave-convex part 221, respectively, such that the concave part of the first concave-convex part 211 is engaged with the convex part of the second concave-convex part 221, and the convex part of the first concave-convex part 211 is engaged with the concave part of the second concave-convex part 221 while interposing the flexible substrate 400 between the concave and convex parts. Accordingly, although the first concave-convex part 211 and the second concave-convex part 221 have different shapes, the concave parts have a complementary shape to mate with the convex parts such that the concave parts are engaged with the convex parts.

The connection part 230 connects the first support part 210 with the second support part 220. The connection part 230 connects a middle portion of the first support part 210, which extends in the front and rear directions, with an end of the second support part 220. The end of the second support part connected to the connection part is a second end of the second support part 220, which is disposed opposite to the first end.

The second support part 220 includes a terminal connection part 240 extending therefrom and having an end exposed at the rear surface of the housing 100 to be connected with an external device. In the terminal connection part 240, a portion exposed to an exterior at the rear surface of the housing 100 corresponds to a terminal 241. The terminal 241 may be connected with an external device through a soldered connection.

In the connector according to an embodiment of the present invention, the first support part 210, the second support part 220, the connection part 230, and the terminal connection part 240 include a conductive material and are integrated with each other.

The end of the first support part 210 positioned closer to the rear surface, that is, the second end of the first support part 210 that extends to the vicinity of the second opening 103, includes at an edge thereof a curved part 213 having an arc shape. The curved part 213 of the first support part 210 supports the rotational motion of the fixing member 300.

The fixing member 300 moves the first end of the first support part 210 by imposing a force on the second end of the first support part 210 through a leverage action. In other words, the fixing member 300 moves the first end of the first support part 210 toward the receiving space, that is, in the lower direction by imposing a force on the second end of the first support part 210 in the upper direction. Accordingly, the space between the first concave-convex part 211 of the first support part 210 and the second concave-convex part 221 of the second support part 220 is narrowed, and the flexible substrate 400 is secured by the pressure of the first concave-convex part 211 in the lower direction.

The fixing member 300 includes a body 310 having a plurality of grooves to receive the terminal part 200 and a pivot part 320 having, for example, an island, oval-cylindrical shape and connecting inner facing surfaces of the grooves with each other while passing through the grooves in the transverse directions. The pivot part 320 is connected with the body 310 and has, for example, an oval sectional shape. The pivot part 320 is interposed between the second end of the first support part 210 and the terminal connection part 240.

If the flexible substrate 400 is not connected with the connector according to an embodiment of the present invention, the body 310 protrudes through the second opening 103 of the housing 100 in the upper direction as shown in FIG. 2A. In order to connect the flexible substrate 400 with the connector, a force is imposed on the protruding portion of the body 310 in the rear direction. If a force is imposed on the protruding portion of the body 310 in the rear direction, the protruding portion of the body 310 rotates about the pivot part 320, so that the body 310 is positioned at the rear side of the terminal part 200 as shown in FIG. 2B.

In more detail, referring to FIG. 2A, if the flexible substrate 400 is not connected with the connector, the pivot part 320 is arranged such that the major axis of the oval sectional shape thereof is substantially parallel to a line extending in the front and rear directions. If the flexible substrate 400 is connected with the connector, the pivot part 320 having the oval shape is rotated. Accordingly, as shown in FIG. 2B, the major axis of the oval sectional shape is parallel to or substantially parallel to a line extending in the upper and lower directions. Accordingly, the second end of the first support part 210 receives a force acting in the upper direction, so that the second end of the first support part 210 is pushed away from the second support part 220, and the first end of the first support part 210 is moved in the lower direction toward the second support part, wherein the connection part 230 acts as a lever. Therefore, the distance between the first ends of the first and second support parts 210 and 220 is reduced, so that the flexible substrate 400 interposed between the first ends is securely fixed.

In this case, a portion of an outer surface of the pivot part 320 has a radius of curvature substantially identical to that of the curved part 213 of the first support part 210. If the pivot part 320 is rotated, the outer surface of the pivot part 320 is securely engaged with the outer surface of the curved part 213 of the first support part 210.

According to an embodiment of the present invention, the fixing member 300 includes insulation materials. The fixing member 300 may include, for example, a material the same as that of the housing 100.

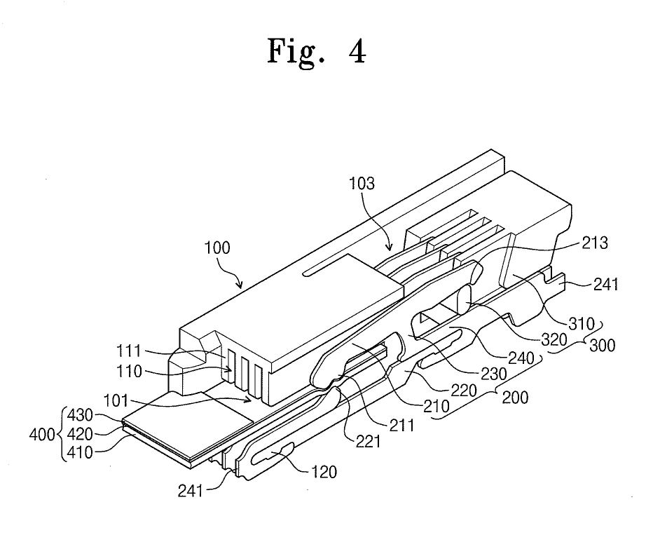

FIG. 3 is a sectional view showing the connector according to an embodiment of the present invention when the flexible substrate 400 is inserted into the receiving space of the connector and the first concave-convex part 211 is engaged with the second concave-convex part 221 and showing a portion of the first support part 210, the second support part 220, and the flexible substrate 400.

Referring to FIG. 3, the first concave-convex part 211 includes two convex parts and concave parts formed between the two convex parts and outside the convex parts. In addition, the second concave-convex part 221 includes one convex part corresponding to the center concave part of the first concave-convex part 211. Accordingly, when the first concave-convex part 211 is engaged with the second concave-convex part 221 while interposing the flexible substrate 400 between the first and second concave-convex parts 211 and 221, the first concave-convex part 211 applies a pressure in the lower direction toward the second concave-convex part 221, and the second concave-convex part 221 applies a pressure in the upper direction toward the first concave-convex part 211. The first and second concave-convex parts 211, 221 may contact each other to the extent possible with the flexible substrate 400 interposed between the first and second concave-convex parts 211, 221.

According to an embodiment, since the flexible substrate 400 has a flexibility, the flexible substrate 400 is bent along the surface of the first concave-convex part 211 and the second concave-convex part 221 due to the engagement between the first concave-convex part 211 and the second concave-convex part 221. Accordingly, the contact surface between the first and second concave-convex parts 211 and 221 and the flexible substrate 400 expands.

If the flexible substrate 400 is pulled in the front direction, since the contact surface between the first and second concave-convex parts 211 and 221 and the flexible substrate 400 becomes expanded, a frictional force is increased between the first and second concave-convex parts 211 and 221 and the flexible substrate 400. In addition, since the flexible substrate 400 is bent along the surface of the first and second concave-convex parts 211 and 221 while making contact with the surface of the first and second concave-convex parts 211 and 221, even if the flexible substrate 400 is pulled in the front direction, a force is dispersed in various directions due to the inclination angles and curvature of the convex and concave parts. Therefore, the effect of a force acting in the front direction is substantially reduced at the flexible substrate 400. Accordingly, even if a force acts from the rear surface to the front surface, the flexible substrate 400 cannot be easily separated from the first and second concave-convex parts 211 and 221, so that the flexible substrate 400 is securely fixed between the first and second concave-convex parts 211 and 221.

Since the flexible substrate 400 is bent along the surfaces of the first and second concave-convex parts 211 and 221, the convex parts of the first and second support parts 210 and 220 overlap with an extending plane, which is at least one of two surfaces of the flexible substrate 400 in parallel to the insertion direction of the flexible substrate 400.

The concave and convex parts of the second concave-convex part 221 may vary in size and number such that the second concave-convex part 221 is engaged with the first concave-convex part 211. Particularly, the second concave-convex part 221 may have a plurality of convex parts. The shape of the second concave-convex part 221 corresponds to the shape of the first concave-convex part 211. The first concave-convex part 211 also may have a plurality of convex parts. According to an embodiment, the first concave-convex part 211 may have a plurality of concave and convex parts, and the convex and concave parts may have various sizes. Accordingly, the second concave-convex part 221 engaged with the first concave-convex part 211 may have a plurality of convex and concave parts. The concave parts of the second concave-convex part 221 engaged with the convex parts of the first concave-convex part 211 may have different sizes and vice versa.

The first support part 210, the second support part 220, the connection part 230, and the terminal connection part 240 include a conductive material, so that electrical signals are transferred to an external device connected with the terminal connection part 240 from the terminal connection part 240 through the first support part 210, the second support part 220, and the connection part 230.

If the metallic layer 420 of the flexible substrate 400 is formed at an upper portion of the flexible substrate 400, the first concave-convex part 211 is electrically connected with the metallic layer 420, so that electrical signals are transferred between the flexible substrate 400 and the external device connected with the terminal connection part 240.

If the metallic layer 420 of the flexible substrate 400 is formed at a lower surface of the flexible substrate 400, the second concave-convex part 221 is electrically connected with the metallic layer 420, so that electrical signals are transferred between the flexible substrate 400 and the external device connected with the terminal connection part 240.

Although the first support part 210, the second support part 220, and the connection part 230 are integrated with each other according to an embodiment of the present invention, the first support part 210 may be separated from the second support part 220 according to another embodiment of the present invention.

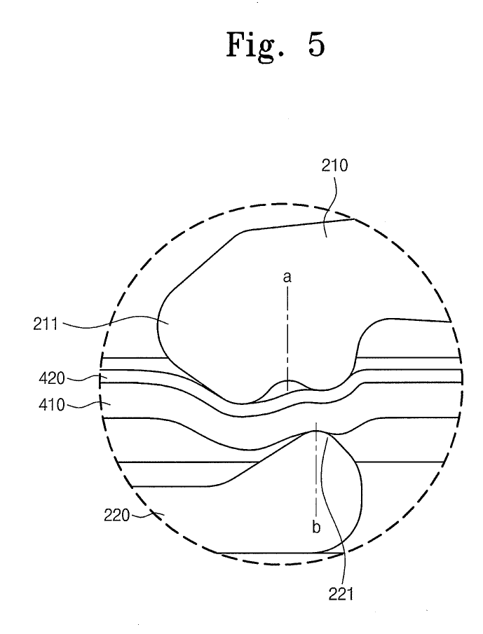

FIG. 4 shows a portion of a connector according to an embodiment of the present invention. Particularly, FIG. 4 is a perspective view showing the connector, according to an embodiment of the present invention, coupled with the flexible substrate 400.

Similar to the embodiment described in connection with FIGS. 1-3, the first support part 210 is disposed at the comb-shaped groove part of the first support wall 111. The first support part 210 extends in the front and rear directions, and is provided at a first end thereof with the first concave-convex part 211 protruding in the direction of the receiving space, that is, the lower direction.

The connection part 230 is provided at a middle portion of the first support part 210 to connect the first support part 210 with the terminal connection part 240. The connection part 230 electrically connects the first support part 210 with the terminal connection part 240. The terminal connection part 240 has a first end connected with the connection part 230 and a second end extending in the rear direction, in which the second end is positioned opposite to the first end. A portion of the second end of the terminal connection part 240 is exposed at the rear surface of the housing 100 to form the terminal 241. An external device may be soldered to the terminal 241 so that the external device is electrically connected with the first support part 210.

According to an embodiment of the present invention, the second support part 220 extends in the front direction, so that one end of the second support part 220 protrudes toward the front surface of the housing 100. The second support part 220 includes the second concave-convex part 221 protruding toward the receiving space at a position corresponding to that of the first concave-convex part 211. A terminal 241 may also be provided at the front surface of the second support part 220 such that the terminal 241 is connected with an external device if necessary.

The first support part 210, the connection part 230, and the terminal connection part 240 may be integrated with each other. In addition, at least one of the second support part 220 and the first support part 210 includes a conductive material, so that the second support part 220 or the first support part 210 is electrically connected with the metallic layer 420 of the flexible substrate 400 through the contact with the metallic layer 420.

According to an embodiment of the present invention, if the metallic layer 420 at the upper portion of the flexible substrate 400 is exposed to connect the first concave-convex part 211 with the metallic layer 420 of the flexible substrate 400, only the first support part 210 needs to be made of a conductive material. In this case, since the second concave-convex part 221 need not have a conductivity, the second concave-convex part 221 may have a non-conductive material. The second concave-convex part 221 may be integrated with the housing 100. If the metallic layer 420 at the lower portion of the flexible substrate 400 is exposed to electrically connect the second concave-convex part 221 with the metallic layer 420 of the flexible substrate 400, only the second support part 220 needs to be made of a conductive material. If all of the metallic layers 420 at the upper and lower portions of the flexible substrate 400 are exposed to supply different electrical signals, the first and second support parts 210 and 220 may include a conductive material. In this case, the terminal 241 of the terminal connection part 240 connected with the first support part 210 and the terminal 241 formed at the second support part 220 are connected with external devices, respectively, to transfer signals.

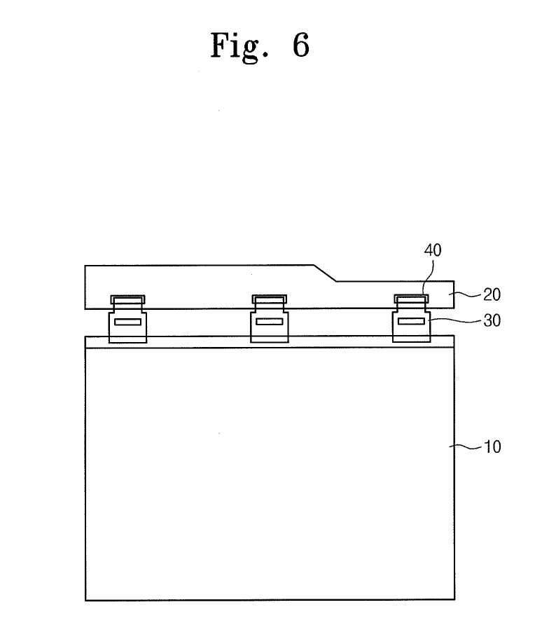

FIG. 5 shows a portion of a connector according to an embodiment of the present invention, and is a sectional view showing the connector, according to an embodiment of the present invention, coupled with the flexible substrate 400.

Referring to FIG. 5, according to an embodiment of the present invention, when the first concave-convex part 211 of the first support part 210 is coupled with the second concave-convex part 221 of the second support part 220 while interposing the flexible substrate 400 between the first concave-convex part 211 and the second concave-convex part 221, the first concave-convex part 211 is offset from the second concave-convex part 221.

In more detail, in the concave and convex parts of the first and concave-convex parts 211, 221, assuming that normal lines at a vertex of each concave part and at a vertex of each convex part are axes a and b of the concave part and the convex part, respectively, the axis a of the concave part of the first concave-convex part 211 does not overlap with the axis b of the convex part of the second concave-convex part 221. Accordingly, the first concave-convex part 211 and the second concave-convex part 221 are provided at different positions with respect to the direction in which the flexible substrate 400 is inserted.

Although the first concave-convex part 211 is engaged with the second concave-convex part 221 while interposing the flexible substrate 400 between the first concave-convex part 211 and the second concave-convex part 221, the first concave-convex part 211 is offset from the second concave-convex part 221, so that a frictional force between the flexible substrate 400, the first concave-convex part 211, and the second concave-convex part 221 is maximized. Accordingly, although a force is imposed on the flexible substrate 400 in the front direction, the flexible substrate 400 is not easily withdrawn out of the connector.

According to an embodiment of the present invention, if the flexible substrate 400 is fitted into the connector, the flexible substrate 400 is electrically connected with the connector. Accordingly, although the flexible substrate 400 has a thickness of about 50 μm or less, the flexible substrate 400 may be effectively fixed, so that the flexible substrate 400 is not be easily separated from the connector.

In addition, the connector according to an embodiment of the present invention increases friction between the connector and the flexible substrate 400 while enhancing the electric connection with the flexible substrate 400, so that the connector is securely connected with the flexible substrate 400 without bonding. Accordingly, the connector is connected with the flexible substrate 400 without a bonding scheme such as outer lead bonding (OLB). The bonding scheme such as the OLB requires not only high-price bonding equipment, but an alignment time between a substrate and a printed circuit board when the substrate is bonded with the printed circuit board. In contrast, the connector according to an embodiment of the present invention is connected with the flexible substrate if the flexible substrate is simply fitted into the connector. Accordingly, the connection procedure is simpler, manufacturing cost is reduced, and manufacturing time is reduced.

The connector according to the embodiments of the present invention transfers electrical signals and is adaptable to many fields to transfer electrical signals without limitation to and from the flexible substrate 400. For example, the connector according to the embodiments of the present invention is used to transfer electrical signals from a printed circuit board to a display panel in a display apparatus.

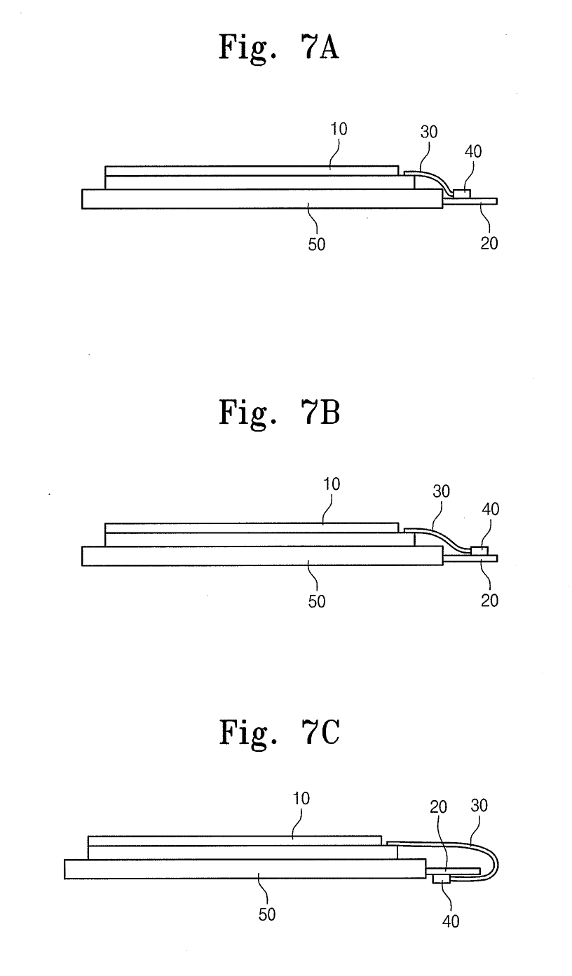

FIG. 6 is a schematic view showing a display apparatus including the connector according to an embodiment of the present invention.

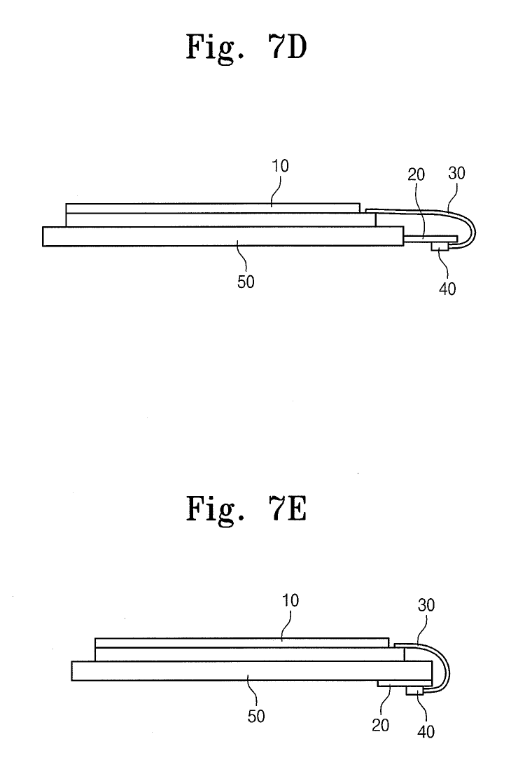

The display apparatus according to an embodiment of the present invention includes a display panel 10, a printed circuit board 20, a flexible substrate 30 interposed between the display panel 10 and the printed circuit board 20, and a connector 40 mounted on the printed circuit board 20 and connected with the flexible substrate 30. In addition, a backlight unit 50 (FIG. 7) is provided on the rear surface of the display panel 10 to supply light to the display panel 10.

The printed circuit board 20 includes a driving circuit to output driving signals. The driving circuit converts driving signals, which are supplied from a controller, into driving signals used to realize images in the display panel 10.

The connector 40 according to an embodiment of the present invention is mounted on the printed circuit board 20. The terminal connection part 240 is provided on at least one of the first and second support parts 210 and 220 of the connector 40 and soldered with the printed circuit board 20, so that electrical signals are transferred between the connector 40 and the printed circuit board 20.

The flexible substrate 30 transfers electrical signals output from the printed circuit board 20 to the display panel 10. To this end, one end of the flexible substrate 30 is bonded with a side of the display panel 10. An opposite end of the flexible substrate 30 is coupled with the connector 40 of the printed circuit board 20.

The flexible substrate 30 may have various thicknesses allowing the connection with the connector 40. For example, the flexible substrate 30 may have a thickness in the range of about 15 μm to about 18 μm.

In the display apparatus according to an embodiment of the present invention, since the flexible substrate 30 is simply fitted into the connector 40 mounted on the printed circuit board 20, the flexible substrate 30 can be easily coupled with the connector 40 regardless of the position of the printed circuit board 20.

FIGS. 7A to 7E are sectional views showing various mounting positions according to the positions of the printed circuit board 20 in the display apparatus according to an embodiment of the present invention. The flexible substrate 30 may be bent in various positions according to the positions of the printed circuit board 20.

Referring to FIGS. 7A to 7D, the backlight unit 50 is provided at a rear surface of the display panel 10, and the printed circuit board 20 is provided at a lateral side of the backlight unit 50, which is also a side portion of the display panel 10. The printed circuit board 20 is fixed with the backlight unit 50 in parallel to a front surface of the display panel 10.

Assuming that a surface of the printed circuit board 20 facing in the same direction as that of the front surface of the display panel 10 is referred to as a front surface of the printed circuit board 20, and a surface of the printed circuit board 20 opposite to the front surface of the display panel 10 is referred to as a rear surface, FIGS. 7A and 7B are views showing the connector 40 formed on the front surface of the printed circuit board 20, and FIGS. 7C and 7D are views showing the connector 40 formed on the rear surface of the printed circuit board 20. In addition, the connector 40 may be provided on the front surface of the printed circuit board 20 or the rear surface in such a manner that the connector 40 is spaced relatively close to the display panel 10 (see FIGS. 7A and 7C) or spaced relatively away from the display panel 10 (see FIGS. 7B and 7D).

Referring to FIG. 7E, the printed circuit board 20 is provided on the rear surface of the backlight unit 50. In this case, the connector 40 is mounted on the rear surface of the printed circuit board 20.

As described above, the mounting position of the connector 40 may vary according to the positions of the printed circuit board 20. The display panel 10 can be connected in various positions with the printed circuit board 20 through the flexible substrate 30. This is possible because the flexible substrate 30 is simply fitted into the connector 40.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A connector receiving a flexible substrate, the connector comprising:
a housing having a receiving space to receive the flexible substrate;
a first support part having a first concave-convex part protruding toward the receiving space; and
a second support part having a second concave-convex part protruding toward the first concave-convex part,
wherein concave and convex parts of the first concave-convex part and convex and concave parts of the second concave-convex part engage the flexible substrate to fix the flexible substrate, and at least one of the first and second support parts electrically contacts the flexible substrate.

2. The connector of claim 1, wherein the flexible substrate is inserted into the receiving space, and the convex parts of the first and second support parts overlap with at least one of two surfaces of the flexible substrate extending in parallel to an insertion direction of the flexible substrate.

3. The connector of claim 2, wherein the first concave-convex part is offset from a position of the second concave-convex part.

4. The connector of claim 1, wherein each of the first and second concave-convex parts comprises a plurality of concave and convex parts, and a number of the concave and convex parts of the second concave-convex part correspond to a number of the concave and convex parts of the first concave-convex part.

5. The connector of claim 1, further comprising a terminal connection part connected with at least one of the first and second support parts and having an end exposed to an exterior.

6. The connector of claim 5, wherein the terminal connection part comprises a conductor, and at least one of the first and second support parts connected with the terminal connection part comprises a conductor.

7. The connector of claim 1, further comprising a connection part connecting the first support part with the second support part, wherein the first and second support parts and the connection part are integrated with each other.

8. The connector of claim 1, wherein the second support part is integrated with the housing.

9. The connector of claim 1, wherein the first concave-convex part is provided at one end of the first support part, the connector further comprises a fixing member contacted with another end of the first support part, and the fixing member applies a force on the other end of the first support part.

10. The connector of claim 9, wherein the force is in a direction away from the receiving space to move the first concave-convex part toward the receiving space.

11. A display apparatus comprising:
a printed circuit board outputting a signal;
a connector mounted on the printed circuit board;
a flexible substrate inserted into and coupled with the connector; and
a display panel connected with the flexible substrate and receiving the signal through the connector and the flexible substrate, wherein
the connector comprises:
a housing having a receiving space to receive the flexible substrate;
a first support part having a first concave-convex part protruding toward the receiving space; and
a second support part having a second concave-convex part protruding toward the first concave-convex part,
and wherein concave and convex parts of the first concave-convex part and convex and concave parts of the second concave-convex part are engaged with the flexible substrate to fix the flexible substrate, and at least one of the first and second support parts electrically contacts the flexible substrate.

12. The display apparatus of claim 11, wherein the flexible substrate is inserted into the receiving space, and the convex parts of the first and second support parts overlap with at least one of two surfaces of the flexible substrate extending in parallel to an insertion direction of the flexible substrate.

13. The display apparatus of claim 12, wherein the first concave-convex part is offset from a position of the second concave-convex part.

14. The display apparatus of claim 11, wherein each of the first and concave-convex parts comprises a plurality of concave and convex parts, and a number of the concave and convex parts of the second concave-convex part correspond to a number of the concave and convex parts of the first concave-convex part.

15. The display apparatus of claim 11, further comprising a terminal connection part connected with at least one of the first and second support parts, and having an end exposed to an exterior to be connected with the printed circuit board.

16. The display apparatus of claim 15, wherein the terminal connection part comprises a conductor, and at least one of the first and second support parts connected with the terminal connection part comprises a conductor.

17. The display apparatus of claim 11, wherein the flexible substrate has a thickness of about 15 μm to about 18 μm.

18. The display apparatus of claim 11, wherein the printed circuit board is provided at a rear surface of the display panel.

19. The display apparatus of claim 11, wherein the printed circuit board is provided at a side portion of the display panel in parallel to a front surface of the display panel.

20. The display apparatus of claim 19, wherein the connector is provided on a top surface of the printed circuit board.

21. The display apparatus of claim 19, wherein the connector is provided on a bottom surface of the printed circuit board.
